(19) United States
(12) Patent Application Publication
(10) Pub. No.: US 2022/0137591 A1
(43) Pub. Date: May 5, 2022

(54) SYSTEM AND METHOD FOR DESIGN AND MANUFACTURE USING MULTI-AXIS MACHINE TOOLS

(71) Applicant: Siemens Industry Software Inc., Plano, TX (US)

(72) Inventors: Janani Venugopalan, Plainsboro, NJ (US); Erhan Arisoy, Princeton, NJ (US); Guannan Ren, Monmouth Junction, NJ (US); Avinash Kumar, Nürnberg (DE); Mehdi Hamadou, Erlangen (DE); Matthias Loskyll, Neumarkt (DE)

(21) Appl. No.: 17/431,225

(22) PCT Filed: Apr. 3, 2019
(86) PCT No.: PCT/US2019/025473

§ 371 Date: Aug. 16, 2021

(51) Int. Cl. G05B 19/4099; G05B 19/408; G06N 3/08; G05B 17/02; G05B 13/04

(52) U.S. Cl. CPC G05B 19/4099; G05B 19/408; G05B 2219/32104; G05B 17/02; G05B 13/048; G06N 3/08

(57) ABSTRACT

A design and manufacturing system includes a multi-axis machine tool including a cutting head able to support a plurality of available tools and a part support, the cutting head and part support fully controllable in at least two axes, a design system operable using a computer to generate a 3-D model of a part to be manufactured, and a machine learning model operable using the computer to analyze the part to be manufactured to identify features and develop a manufacturing plan at least partially based on the multi-axis machine tool and the plurality of available tools, the manufacturing plan including a type of tool used for each feature, a feed-rate for each type of tool for each feature, and a speed of the tool for each type of tool for each feature.

### TECHNICAL FIELD

The present disclosure is directed, in general, to a system and method for designing and manufacturing a part using a multi-axis machine tool, and more specifically to such a system and method using a multi-axis machine tool including at least three axes.

### BACKGROUND

Machine tools, and in particular multi-axis machine tools are used to manufacture complex parts efficiently and accurately. However, parts with increased complexity often require more complex machine tools including machine tools that control three or more axes simultaneously. Significant expertise and experience are needed to properly program and operate these machines.

### SUMMARY

A design and manufacturing system includes a multi-axis machine tool including a cutting head able to support a plurality of available tools and a part support, the cutting head and part support fully controllable in at least two axes, a design system operable using a computer to generate a 3-D model of a part to be manufactured, and a machine learning model operable using the computer to analyze the part to be manufactured to identify features and develop a manufacturing plan at least partially based on the multi-axis machine tool and the plurality of available tools, the manufacturing plan including a type of tool used for each feature, a feed-rate for each type of tool for each feature, and a speed of the tool for each type of tool for each feature.

In another construction, a method of designing and manufacturing a part includes training a machine learning module to recognize manufacturing features and to develop manufacturing plans for those features using a general data set, the manufacturing plans including machine tool parameters for each step in the manufacturing plan. The method also includes training the machine learning module further using a user-specific data set, building a 3-D model of the part, the part including a plurality of features, analyzing, using the machine learning module the 3-D model to identify features of the part, and developing a manufacturing plan using the machine learning module, the manufacturing plan including the manufacturing steps and machine tool parameters for each step. The method also includes transmitting the manufacturing plan and parameters to a multi-axis machine tool including a cutting head able to support a plurality of available tools and a part support, the cutting head and part support fully controllable in at least two axes and implementing the manufacturing plan to manufacture the part.

In another construction, a design and manufacturing system includes a multi-axis machine tool including a cutting head able to support a plurality of available tools and a part support, the cutting head and part support fully controllable in at least three axes, and a user-specific data set specific to the user and including at least past experience data and an available tool inventory. A design system is operable using a computer to generate a 3-D model of a part to be manufactured, the part including a plurality of features and a machine learning model operable using the computer to analyze the part to be manufactured to identify features of the part to be manufactured based at least in part on the user-specific data set, the machine learning model further defining a plurality of operations and a plurality of machining parameters for each of the plurality of operations for each feature of the part to be manufactured, the plurality of machining parameters including a type of tool, a feed-rate, and a speed of the tool.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the Detailed Description below, it should be understood that various definitions for certain words and phrases are provided throughout this specification and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIG. 1 is a perspective view of a multi-axis machine tool.

FIG. 2 is a perspective view of a part to be manufactured.

FIG. 3 is a flow chart illustrating one embodiment for training and using a machine learning model to develop a manufacturing plan use by the machine tool of FIG. 1.

FIG. 4 is a flow chart illustrating another embodiment for training and using the machine learning model to develop the manufacturing plan use by the machine tool of FIG. 1.

FIG. 5 is a flowchart illustrating the training and use of the machine learning model to develop the manufacturing plan use by the machine tool of FIG. 1.

FIG. 6 is a schematic illustration showing the relationship between parts, features, steps, and parameters.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

Also, it should be understood that the words or phrases used herein should be construed broadly, unless expressly limited in some examples. For example, the terms “including,” “having,” and “comprising,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In addition, the term “adjacent to” may mean: that an element is relatively near to but not in contact with a further element; or that the element is in contact with the further portion, unless the context clearly indicates otherwise. Further, the phrase “based on” is intended to mean “based, at least in part, on” unless explicitly stated otherwise. Terms “about” or “substantially” or like terms are intended to cover variations in a value that are within normal industry manufacturing tolerances for that dimension. If no industry standard as available a variation of 20 percent would fall within the meaning of these terms unless otherwise stated.

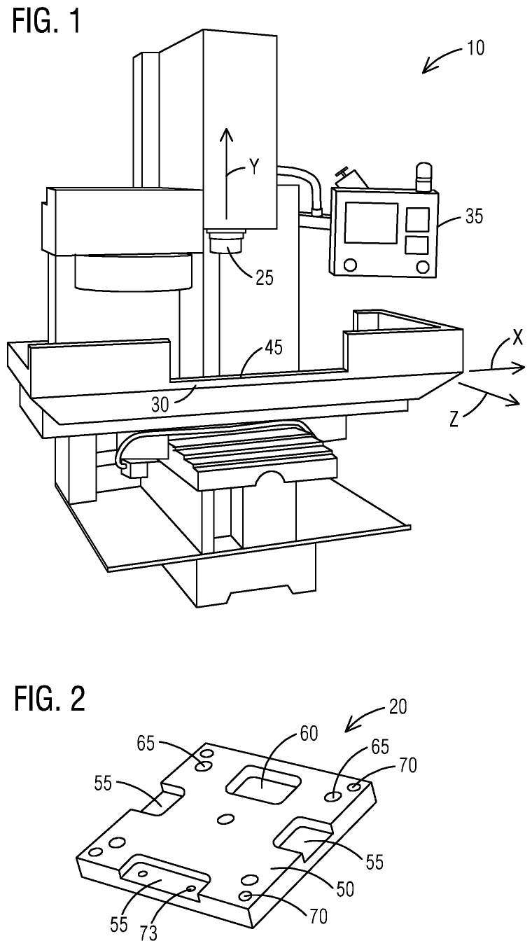

The following description references machine tools 10 (shown in FIG. 1) having different levels of axis control. These machine tools 10 are commonly referred to as 2.5-axis machines, 3-axis machines, 3.5-axis machines, 4-axis machines, and so on. For purposes of the following description, these machine tools 10 should be understood as having full control of the number of axis identified prior to the decimal point and at least partial control of one additional axis if a number (typically “5”) follows the decimal point. Full control means that the acceleration, velocity, and direction of the controlled axes can be simultaneously changed and controlled as desired. A partially controlled axis can be moved and controlled but it cannot generally be moved and controlled in conjunction with the other axes. Thus, a machine identified as a 2.5-axis machine would be capable of fully controlled, simultaneous movement and acceleration in the X and Y directions (or X and Z or Y and Z) with movement in the Z direction (or the Y or X) being possible but not fully controlled in conjunction with the other two axes. A 3-axis machine would be capable of fully controlled, simultaneous movement and acceleration in the X, Y, and Z directions but would not include any rotational movements. A 3.5-axis machine would add the ability for rotation (e.g., a rotary support table) but that rotation would not be integrated and fully controllable like movement in the X, Y, and Z directions. A 4-axis machine adds full control of the rotational movement in conjunction with the X, Y, and Z movement.

The design and manufacture of parts has become an integrated process in which the part is designed using computer-aided design (CAD) tools that typically generate a 3D model of the part or device to be manufactured. A computer-aided manufacturing module (CAM), often part of the CAD system is then used to determine how best to manufacture the part. While the machining steps for some features can be automatically generated, these pre-programed steps are generally provided by the CAM system provider and are often very general and limited. An experienced user is required to adjust any automatically generated parameters and to add parameters that could not be automatically generated for most applications.

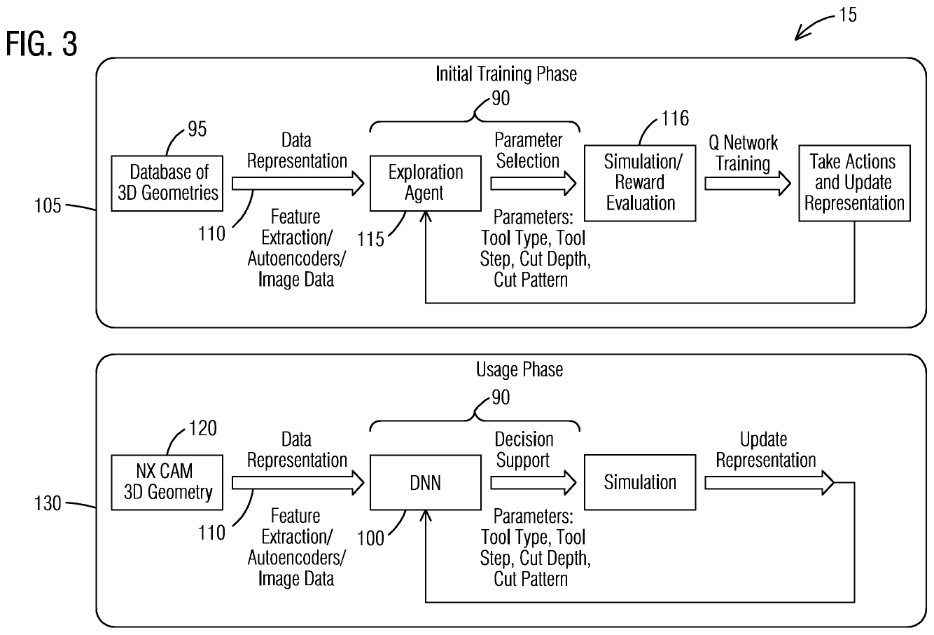

FIGS. 3-5 illustrate a computer-implemented enhanced design system 15 that utilizes advanced artificial intelligence (AI) to enhance the design process just described to reduce wasted time, increase engineering productivity, and produce superior quality designs and manufacturing plans.

The software aspects of the present invention could be stored on virtually any computer readable medium including a local disk drive system, a remote server, the internet, or cloud-based storage locations. In addition, aspects could be stored on portable devices or memory devices as may be required. The computer generally includes an input/output device that allows for access to the software regardless of where it is stored, one or more processors, memory devices, user input devices, and output devices such as monitors, printers, and the like.

The processor could include a standard micro-processor or could include artificial intelligence accelerators or processors that are specifically designed to perform artificial intelligence applications such as artificial neural networks, machine vision, and machine learning. Typical applications include algorithms for robotics, internet of things, and other data-intensive or sensor-driven tasks. Often AI accelerators are multi-core designs and generally focus on low-precision arithmetic, novel dataflow architectures, or in-memory computing capability. In still other applications, the processor may include a graphics processing unit (GPU) designed for the manipulation of images and the calculation of local image properties. The mathematical basis of neural networks and image manipulation are similar, leading GPUs to particularly useful for machine learning tasks. Of course, other processors or arrangements could be employed if desired. Other options include but are not limited to field-programmable gate arrays (FPGA), application-specific integrated circuits (ASIC), and the like.

The computer also includes communication devices that may allow for communication between other computers or computer networks, as well as for communication with other devices such as machine tools, work stations, actuators, controllers, sensors, and the like.

FIG. 1 includes an example of a multi-axis machine tool 10 commonly used to manufacture parts 20 (shown in FIG. 2) or components. The illustrated machine tool 10 is a vertical milling center with other machine tools including horizontal milling centers, lathes, and the like. The illustrated machine tool 10 is a three-axis machine tool that includes a cutting head 25, a part support 30, a computer 35, and a plurality of actuators (not shown). The cutting head 25 includes a chuck or other mounting device that allows the cutting head 25 to engage and utilize a plurality of tools. The tools could include a number of cutting tools including end mills, drill bits, reamers, taps, and the like. The cutting head 25 is movable along a vertical or “Y” axis to move the tool being supported toward or away from the part support 30.

The part support 30 includes a table 45 arranged to fixedly hold the material being machined in place. Clamping devices, magnets, or other restraining arrangements could be employed to restrain the part 20 on the table 45. The part support 30, including the table 45 is movable in two directions (“X” and “Z”) to move the material being machined in a plane that is normal to the vertical or “Y” axis.

Actuators (not shown), typically in the form of variable speed electric motors are positioned within a housing 50 of the machine tool 10 with each actuator operable to control movement along one of the three axes X, Y, Z. Two actuators move the part support 30 to move the material being machined in either the X direction or the Z direction, at any speed between zero and a maximum rate of travel, in either direction along the axes, and between any set limits of travel. A third actuator is operable to move the cutting head 25 vertically along the Y axis. Again, the actuator is capable of moving in either direction along the axis, at any speed between zero and a maximum speed, and between any stops that are established. The three actuators described are thus capable of positioning the tool at any desired position in space using the three actuators. If the machine tool 10 of FIG. 1 was a four-axis machine, it would also allow for rotation of the material being machined or the cutting head 25 about one of the three primary axes. For example, the part support 30 could be rotated about the X axis or the Z axis to reorient the material being machined with respect to the cutting head 25.

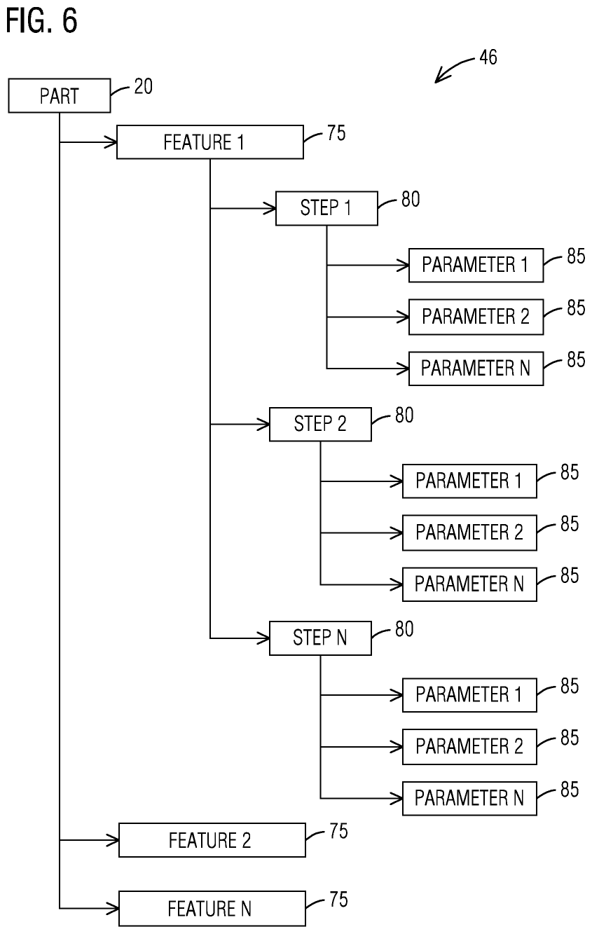

The computer 35 is coupled to each of the actuators and includes a program that follows a manufacturing plan 46 (shown in FIG. 6) to control the actuators and manufacture the part 20 from the material being machined. The manufacturing plan 46 may be thought of as a list of features 75 to be machined in a particular order and with each feature 75 including a list of steps 80 that need to be performed to complete that feature 75. Various parameters 85 (e.g. tool cutter diameters, step over type and length, depth of cut and type of cut, cutting pattern, feed rate, spindle speed, blank material type, and tool material type, etc.) are assigned to each step 80 to assure proper manufacture of the part 20.

For example, to manufacture the part 20 illustrated in FIG. 2, the manufacturing plan 46 may include features 75 to be machined such as a planar top surface 50, first, second, and third open pockets 55, a closed pocket 60, five large through holes 65, four small through holes 70, and two tapped holes 73. The features 75 are arranged in an order that is efficient for the overall machining process.

As illustrated in FIG. 6, each feature 75 may then have multiple steps 80 with different parameters 85 for each step 80. Steps 80 could be considered the different operations required to form a surface or feature 75. Steps 80 could be defined by the tool employed but one could also include rough machining as a step 80, semi-finish machining as another step 80, and finish machining as another step 80. Parameters 85 can include any variable that is controllable and that influences the machining process. In addition, some features 75 may be manufactured as three separate features 75 with the first feature 75 being the rough machining of the feature 75, the second feature 75 being the semi-finish machining, and the final feature 75 being the finish machining of the feature 75. Using this arrangement, each feature 75 of the part 20 might be rough machined in a particular order with that order being repeated for each feature 75 to semi-finish and finish machine the part 20. Common parameters 85 include but are not limited to a type of tool used, a feed-rate, a rotational speed, a tool size, a cut depth, a step over length, a cutting pattern, and the like.

For example, the first feature 75 in the machining plan for the part 20 of FIG. 2 might be to machine the top planar surface 50. The steps 80 involved to complete this feature 75 include rough machining of the surface 50. This may use a large end mill with a high feed-rate and a large cut depth (parameters 85). The cutting pattern and step over length provide little to no overlap to assure the fastest possible machining. However, the surface finish and accuracy are not desirable. The second step 80 might be to semi-finish the surface 50. Slower feed rates, with tighter step over lengths and a cutting pattern with additional overlap (parameters 85) greatly improve the surface finish and accuracy. The final step 80 might be to finish machine the surface 50. However, this step 80 could be performed at the end of the manufacturing to assure the best quality surface.

The next feature 75 to be formed might be one of the open pockets 55 or the closed pocket 60. For the closed pocket 60, the first step 80 might be a plunge bore that allows access for an end mill. Again, rough machining, followed by semi-finish, and finish machining could be employed.

While the part 20 illustrated in FIG. 2 is simple compared to many other parts (e.g., turbine blade), more complex parts may include many features 75 requiring hundreds of steps 80. Selecting the parameters 85 and the order for performing each step 80 can be challenging and often requires a significant level of skill and experience.

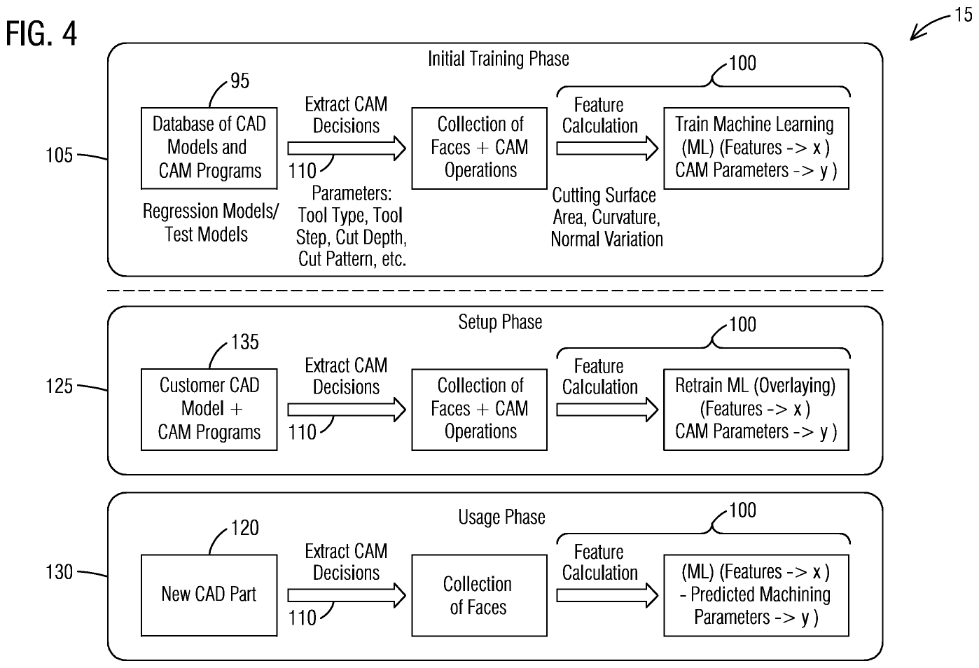

To aid the engineer, the enhanced design system 15 illustrated herein includes a machine learning module 90 shown in FIGS. 3 and 4 that is capable of generating complete manufacturing plans 46 including each step 80 and parameters 85 for each step 80.

Machine tool providers as well as CAD/CAM (Computer-Aided Design/Computer-Aided Manufacture) providers often provide a dictionary of manufacturing rules that provide tool chain and tool parameters for manufacturing or forming certain features 75. However, these rules are often very simple and limited to simple or common features 75 using common materials. Thus, a skilled user is still often required to optimize the steps 80 and parameters 85 provided in the rules for particular applications.

Although these manufacturing rule dictionaries are generated using knowledge from manufacturing experts and user feedback, users are still expected to adjust and modify the out-of-box rule-dictionaries for customization purposes based on their manufacturing experiences. However, these dictionaries are often very limited as they only include a limited number of features 75 and materials. In addition, the number of parameters 85 involved in a manufacturing plan 46 increases dramatically as the number of axes being controlled increases such that these dictionaries are of limited value for systems including more than 2.5 controlled axes.

To alleviate this challenge, the machine learning module 90 learns customers' preferences and automatically adjusts and modifies the customer's manufacturing rule dictionary. The machine learning module 90 is a computer-based system that preferably includes a neural network 100. The neural network 100 is trained using existing manufacturing plans for known features 95. For example, the vendor provided dictionaries could be a source for teaching.

In preferred constructions deep learning methods, and in particular reinforcement learning techniques are employed to teach the neural network 100 how to form complex manufacturing plans 46 from the available simple rules.

The neural network 100 can be combined with reinforcement learning algorithms to create the prepared machine learning model. Reinforcement learning refers to goal-oriented algorithms, which learn how to attain a complex objective (goal) or maximize along a particular dimension over many steps; for example, maximize the points won in a game over many moves. These algorithms are penalized when they make the wrong decisions and rewarded when they make the right ones.

FIG. 3 illustrates one possible sequence for training and using the machine learning module 90 including the neural network 100 using reinforcement learning to predict the sequence of design parameters needed for CAD/CAM planning and machining. Specifically, FIG. 3 illustrates the training and use of a deep learning network (DNN) 100 which encompasses deep Q learning networks (DQN) and residual networks. The DNN, such as a CNN, DQN, or residual networks may further include machine learning (ML) models such as Random Forests or a similar prediction algorithm.

A database of known 3D geometries 95 is used to train the DQN 100 which learns to predict a sequence of tools and parameters 85 for features 75 that are extracted from 3D data. The database of known 3D geometries 95 can include data provided by the final user that is specific to that user's processes as well as data provided by other sources. So long as the data includes a 3D model of a part or component to be manufactured and a known suitable manufacturing plan, it can be used for training.

With reference to FIG. 3, initial training 105 begins by extracting features from the 3D models 95 that are provided. In this phase, generic 3D models 95 (non-user specific) are provided to a feature extraction algorithm 110 that is employed to extract or detect the various faces of the part being used for training. Typically, a CAD representation (part file) is analyzed using topological graph matching algorithms to identify manufacturing features 75 such as pockets, holes, slots, and the like. An exploration agent 115 analyses the various features 75 and develops a manufacturing plan 46 for each feature 75 using the DQN 100. The manufacturing plan 46 includes the tool type, tool step, cut depth, cut pattern, etc. This plan 46 can be simulated or compared to the known manufacturing plan 95 for the particular feature 75 to determine the quality of the selected manufacturing plan 46. When using reinforcement learning, this step includes a reward evaluation 116. The DQN 100 is then updated and additional action is taken as required. If the predicted manufacturing plan 46 is not a match to the known plan 95, the additional action could be to re-predict the manufacturing plan 46 using the revised DQN 100. This iterative process repeats until the predicted manufacturing plan 46 matches the known manufacturing plan 95.

Once the DQN 100 is properly trained, it can be used by a user. The user provides a new 3D model or 3D geometry 120 to the computer including the DQN 100. As with training, the feature extraction algorithm 110 extracts the features 75 of the part 20 or device to be manufactured. The DQN 100 is used to develop the manufacturing plan 46 and to select the various parameters 85 for each step 80 in the manufacturing plan. A manufacturing simulation is then run to verify the selections. The user is able to update the parameters 85, change or add steps 80, or identify features 75 missed by the DQN 100 for the manufacturing plan 46 in view of the simulation and these updates are fed back to the DQN 100 to further train the DQN 100 to improve the parameter selection on the next use.

The use of general 3D geometry and manufacturing plans 95 (i.e., not user specific) often results in features, 75, steps, 80, and parameters 85 being selected that require significant adjustment. For example, a plastic manufacturer may be able to use significantly higher tool speeds and feed rates than are predicted by the DQN 100 if the training of the DQN 100 was based heavily on manufacturing using steel or other metals.

FIG. 4 illustrates another construction in which initial training 105 is used to initially train the DQN 100 as in FIG. 3, followed by a setup phase 125 that further trains the DQN 100, followed by a usage phase 130 similar to that described with regard to FIG. 3.

As illustrated in FIG. 4, the DQN 100 is initially trained using the same 3D models and known manufacturing plans 95 used in the construction of FIG. 3. The training proceeds as described with regard to FIG. 3 such that at the completion of the initial training 105, the DQN 100 of FIG. 4 would be identical to or substantially the same as the DQN 100 of FIG. 3.

However, the construction of FIG. 4 includes an additional training phase, referred to as the setup phase 125. The setup phase 125 proceeds in a similar manner to the initial training phase 105 but uses user specific 3D models and manufacturing plans 135. This allows for customization of the DQN 100 based on actual user experience. To allow continuous customization and improvement to personalization, learning can continue during use of the module 90 by incorporating changes that are made to predictions by the user. The overall goal of this is to function as a decision support system for multi-axis machining problems and to improve the efficiency of the designer and other users. Once the setup phase 125 is complete, the user can use the DQN 100 as described with regard to FIG. 3.

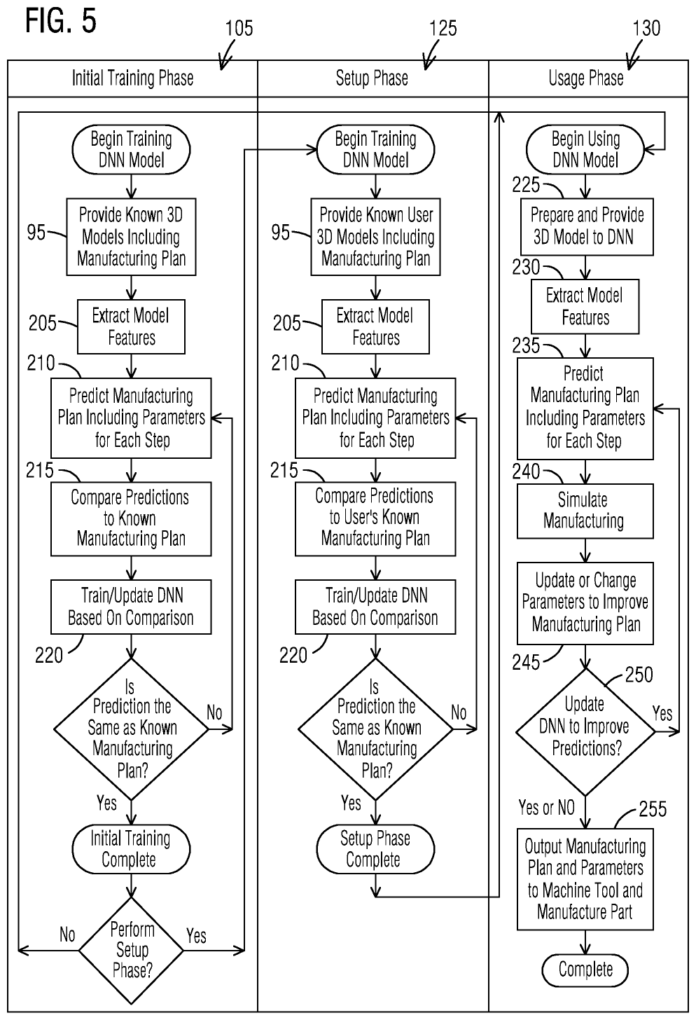

FIG. 5 is a flow chart illustrating the initial training phase 105, the setup phase 125, and the usage phase 130. Regardless of the use, the initial training phase 105 should be performed to improve operation over a system that relies solely on manufacturing rule dictionaries provided by software providers. In the initial training phase 105, known 3D models and manufacturing plans 95 are provided to the enhanced design system 15. Model features are extracted at step 205. The DQN or neural network 100 of the enhanced design system then predicts a manufacturing plan at step 210 and that plan is compared to the known plan 95 at step 215. The DQN 100 is updated at step 220 based on the comparison at step 215. Again, the use of reinforcement learning techniques quickly improves the predictions made by the DQN 100. This process is repeated using a desired number of available known models and manufacturing plans 95 to complete the initial training phase 105.

Next, a decision is made regarding the need for a setup phase 125. If no setup phase 125 is performed, the user proceeds to the usage phase 130. However, if a setup phase is performed, it follows the same steps as the initial training phase 105 but uses known models and manufacturing plan that are specific to the particular user. This step greatly improves the predicted manufacturing plans 46 provided by the enhanced design system 15.

In the usage phase 130, the user provides a 3D model 120 to the enhanced design system 15 at step 225 and the feature extraction algorithm 110 extracts the features 75 at step 230. The DQN 100 then predicts a manufacturing plan 46 for those features at step 235. The manufacturing plan 46 can be simulated at step 240 and the manufacturing plan updated at step 245. Any updates can be fed back to the DQN at step 250 to improve future predictions made by the DQN while the manufacturing plan 46 is simultaneously output to one or more machine tools (step 255) to facilitate the manufacture of the part. It should be understood that many steps illustrated in FIG. 5 could be omitted and additional steps could be required to properly implement certain arrangements of the enhanced design system 15. As such, none of the steps of FIG. 5 should be considered as required and additional steps should not be precluded.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

1. A design and manufacturing system comprising:
a multi-axis machine tool including a cutting head able to support a plurality of available tools and a part support, the cutting head and part support fully controllable in at least two axes;
a design system operable using a computer to generate a 3-D model of a part to be manufactured; and
a machine learning model operable using the computer to analyze the part to be manufactured to identify features and develop a manufacturing plan at least partially based on the multi-axis machine tool and the plurality of available tools, the manufacturing plan including a type of tool used for each feature, a feed-rate for each type of tool for each feature, and a speed of the tool for each type of tool for each feature.

2. The design and manufacturing system of claim 1, wherein the cutting head of the multi-axis machine tool is fully controllable in three axes.

3. The design and manufacturing system of claim 2, wherein the manufacturing plan includes at least the type of tool, the feed-rate, the speed, a tool size, a cut depth, a step over length, a cutting pattern, and a feed-rate for each machining step in the manufacturing plan.

4. The design and manufacturing system of claim 3, further comprising a simulation module operable using the computer to simulate the manufacturing plan.

5. The design and manufacturing system of claim 1, wherein the machine learning model includes a prediction algorithm that is at least partially trained using a general data set.

6. The design and manufacturing system of claim 5, wherein the prediction algorithm of the machine learning model is at least partially trained using a user-specific data set in addition to the general data set.

7. The design and manufacturing system of claim 5, wherein the prediction algorithm includes a neural network.

8. The design and manufacturing system of claim 5, wherein the prediction algorithm is obtained by training a Deep Q learning model (DQN) and a neural network.

9. A method of designing and manufacturing a part, the method comprising:
training a machine learning module to recognize manufacturing features and to develop a manufacturing plan for those features using a general data set, the manufacturing plan including machine tool parameters for each step in the manufacturing plan;
training the machine learning module further using a user-specific data set;
building a 3-D model of the part, the part including a plurality of features;
analyzing, using the machine learning module the 3-D model to identify features of the part;
developing a manufacturing plan using the machine learning module, the manufacturing plan including manufacturing steps and machine tool parameters for each step;
transmitting the manufacturing plan and parameters to a multi-axis machine tool including a cutting head able to support a plurality of available tools and a part support, the cutting head and part support fully controllable in at least two axes; and
implementing the manufacturing plan to manufacture the part.

10. The method of designing and manufacturing the part of claim 9, wherein the cutting head of the multi-axis machine tool is fully controllable in three and only three axes.

11. The method of designing and manufacturing the part of claim 10, wherein the machine tool parameters include at least a type of tool, a feed-rate, a speed, a tool size, a cut depth, a step over length, a cutting pattern, and a feed-rate for each machining step in the manufacturing plan.

12. The method of designing and manufacturing the part of claim 9, further comprising simulating the manufacturing plan using a computer.

13. The method of designing and manufacturing the part of claim 9, wherein the machine learning module includes a neural network.

14. The method of designing and manufacturing the part of claim 13, further comprising training a Deep Q learning model (DQN) and the neural network to obtain a prediction algorithm operable to recognize the manufacturing features and to develop the manufacturing plan.

15. A design and manufacturing system comprising:
a multi-axis machine tool including a cutting head able to support a plurality of available tools and a part support, the cutting head and part support fully controllable in at least three axes;
a user-specific data set specific to a user and including at least past experience data and an available tool inventory;
a design system operable using a computer to generate a 3-D model of a part to be manufactured, the part including a plurality of features; and
a machine learning model operable using the computer to analyze the part to be manufactured to identify features of the part to be manufactured based at least in part on the user-specific data set, the machine learning model further defining a plurality of operations and a plurality of machining parameters for each of the plurality of operations for each feature of the part to be manufactured, the plurality of machining parameters including a type of tool, a feed-rate, and a speed of the tool.

16. The design and manufacturing system of claim 15, wherein the cutting head of the multi-axis machine tool is fully controllable in three and only three axes.

17. The design and manufacturing system of claim 16, wherein the plurality of machining parameters further include a cut depth, a step over length, a cutting pattern, and a feed-rate for at least a portion of the plurality of operations.

18. The design and manufacturing system of claim 17, further comprising a simulation module operable using the computer to simulate the plurality of operations.

19. The design and manufacturing system of claim 15, wherein the machine learning model includes a prediction algorithm that is at least partially trained using a general data set.

20. The design and manufacturing system of claim 19, wherein the prediction algorithm of the machine learning model is at least partially trained using the user-specific data set in addition to the general data set.

21.-22. (canceled)
